(19) United States
(12) Patent Application Publication
(10) Pub. No.: US 2008/0115420 A1
(43) Pub. Date: May 22, 2008

(54) Vehicle window positioning assembly and method

(76) Inventors: Michael Kidd, Oxford, MI (US); Lawrence J. Olivieri, Lake Orion, MI (US)

Correspondence Address: WHITE & CASE LLP;PATENT DEPARTMENT, 1155 AVENUE OF THE AMERICAS, NEW YORK, NY, 10036, US

(21) Appl. No.: 11/562,276

(22) Filed: Nov. 21, 2006

(51) Int. Cl. B60J 5/04

(52) U.S. Cl. 49/502

(57) ABSTRACT

An up-stop mechanism for a vehicular window provides, in some embodiments of the present invention, a means of adjustment of a window position from inside the vehicle, rather than, for example, through its beltline. Embodiments of the present invention may also permit adjustment of the window without loss of the position of the up stop and, with it, the vertical limit of the controlled window pane. Fine adjustment of the window position is also enabled through the use of indirect control of the position of the up stop and gradations on an adjacent base plate, on which the up stop is adjustably mounted. Embodiments of the present invention may provide an adjustment interface on a portion of an up stop, while a complementary interface, designed to engage the adjustment interface of the up stop, may be provided on an adjusting component, most preferably one that is borne or mounted separately from the up stop. Actuation of the adjusting component displaces its engaging interface and, by doing so, indirectly displaces the engaging interface of the up stop and, thus, the up stop itself. The adjusting component may be acted upon by a preselected tool, such as a wrench, and may be mounted in order to be accessed from inside the vehicle.

### FIELD OF THE INVENTION

The present invention relates, in general, to vehicle window regulators and, in particular, to vehicular window up stop adjustment.

### BACKGROUND

The control of vehicle window panes involves, among other things, effectuating a stop upon the window when moving upwardly to a closed position. A mechanism that acts in this capacity, limiting the range of the window to a desired terminal position, is sometimes referred to as an “up stop.”

Conditions for mounting and controlling a vehicular window pane may vary by type and individual vehicle, as well as other conditions. Controlling the position of the extreme vertical limit of a vehicle window pane is accordingly a maintenance adjustment preferably made in a manner that minimizes time and effort of maintenance personnel, while at the same time ensuring an adequate degree of control.

Existing up stop mechanisms may involve use of a slot and screw, as shown in FIGS. 1A and 1B. In those figures, up stop 2 is held in position with respect to vehicle door 3 by screw 4 within slot 6. Though perhaps adequate for setting a position in the first instance, when the screw 6 is loosened, the up stop 2 may slide, undesirably, within the slot 6, due to gravity or other force, from its original position. If a maintenance provider, when beginning the position setting task, understood the magnitude of an adjustment required for proper window placement, that knowledge would be useless because the original position would have been lost due to the sliding of the up stop 2 from that position. Fine adjustment, too, may be elusive with this approach. The screw 6 only permits adjustment not of the up stop 2, but of the ability to move the up stop 2. Thus, there is no mechanism for gradually modulating the vertical position of the up stop 2.

In another existing approach, fine adjustment of the vertical limit of a vehicle window is sought be means of a jack screw. A jack screw, however, requires access through the vehicle belt line.

### SUMMARY OF THE INVENTION

The needs alluded to above, and other long-felt but previously unmet needs, are addressed, at least in part, by various aspects of the present invention. An up-stop mechanism for a vehicular window, in some embodiments of the present invention, provides a means of adjustment of a window position from inside the vehicle, rather than, for example, through its beltline. Embodiments of the present invention may also permit adjustment of the window without loss of the position of the up stop and, with it, the vertical limit of the controlled window pane. Fine adjustment of the window position is also enabled through the use of indirect control of the position of the up stop and gradations on an adjacent base plate, on which the up stop is adjustably mounted. Embodiments of the present invention may provide an adjustment interface on a portion of an up stop, while a complementary interface, configured to engage the adjustment interface of the up stop, may be provided on an adjusting component, most preferably one that is borne or mounted separately from the up stop. Actuation of the adjusting component displaces its engaging interface and, by doing so, indirectly displaces the engaging interface of the up stop and, thus, the up stop itself. The adjusting component may be acted upon by a preselected tool, such as a wrench, and may be mounted in order to be accessed from inside the vehicle.

In one aspect of the present invention, an assembly is provided for adjusting a position of a window of a vehicle, which has a primary axis of motion when opening and closing. The assembly comprises a stop mechanism (e.g., an up stop) defining a limit on motion of the window along the primary axis, the stop mechanism being movably mounted with respect to the vehicle and having an engageable adjustment interface. The assembly further comprises an adjustment component mounted to the vehicle proximate the stop mechanism, the adjustment component having an interface for engaging the adjustment interface of the stop mechanism.

In another of its aspects, the present invention provides for a device for adjusting a position of a window of a vehicle, the window having a primary axis of motion when opening and closing. The device for use with an adjustment component may be mounted to the vehicle proximate the device, the adjustment component having an engagement interface for effecting an adjustment. The device according to this aspect of the present invention includes a stop, e.g., an up stop, defining a limit on motion of the window along the primary axis, the stop mechanism being mounted to be movable, along the primary axis, with respect to the vehicle, and having an engageable adjustment interface, the engageable adjustment interface adapted to be engaged by the engagement interface of the adjustment component.

In an embodiment of yet another aspect of the present invention, an assembly is provided for adjusting the position of a stop mechanism for a window of a vehicle, the window having a primary axis of motion when opening and closing and the stop placing a limit on motion of the window along the primary axis, and the stop mechanism also being movably mounted with respect to the vehicle and having an engageable adjustment interface. The assembly may include: an adjustment component mounted to the vehicle proximate the stop mechanism, the adjustment component having an interface for engaging the adjustment interface of the stop mechanism; the adjustment component mounted to permit it to be moved during an adjustment operation, such that the motion of the adjustment component causes an adjustment in the position of the stop mechanism. A position of a limit of the window's position along the primary axis of motion is thereby adjusted.

Another aspect of the present invention provides a method for adjusting a limit on a position of a window of a vehicle. The limit is defined by a stop (e.g., an up stop) that is movably mounted on the vehicle and acted upon by an adjustment component separately mounted on the vehicle. The method comprises the steps of: engaging the adjustment component with a tool; actuating the adjustment component with the engaged tool to cause a resultant movement of the stop; and ceasing actuation of the adjustment component with the engaged tool when the stop has reached a desired position.

The devices and methods according to the present invention address, at least in part, shortcomings of previous approaches. Other embodiments, objects and advantages of the present invention will be apparent from the following description, the accompanying figure and the appended materials, which are incorporated herein by reference in their entirety.

### BRIEF DESCRIPTION OF THE FIGURES

FIGS. 1A and 1B show alternative views of an example of an adjustable up stop of a window regulator according an approach known in the art.

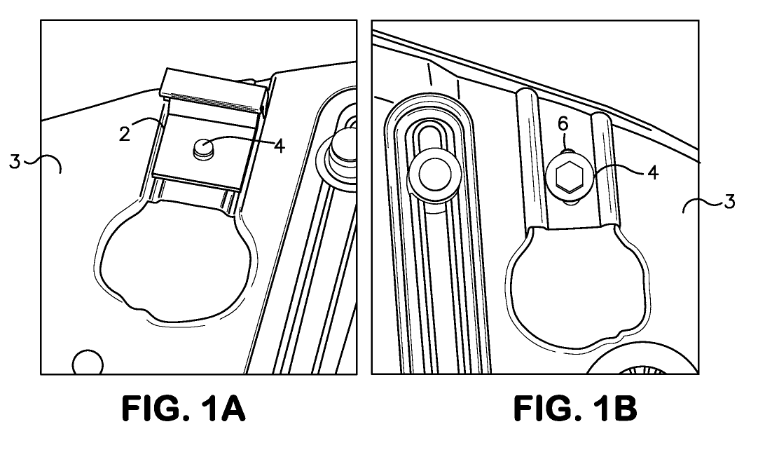

FIG. 2 shows an embodiment of an adjustable up stop assembly for a vehicle window, according to the present invention, as viewed from a position on the exterior of the vehicle, the up stop shown in a first position.

FIG. 3 shows the embodiment of an adjustable up stop assembly for a vehicle window shown in FIG. 2, as viewed from a position on the interior of the vehicle.

FIG. 4 shows the embodiment of an adjustable up stop assembly for a vehicle window shown in FIG. 2, as viewed from a position on the exterior of the vehicle, the up stop shown in a second position.

### DETAILED DESCRIPTION OF THE INVENTION

This description, including the figures, sets forth embodiments of various aspects of the present invention. These embodiments are not intended to, and do not, limit the scope of the present invention, in any of its aspects, to particular details.

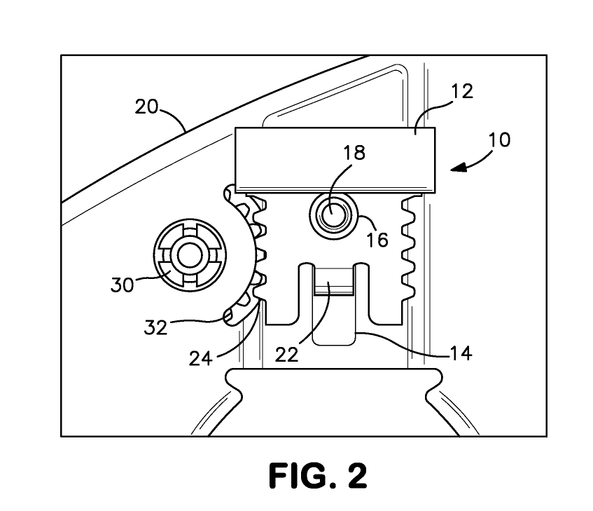

One embodiment of the assembly according to the present invention is described below with reference to FIG. 2. An up stop 10, which may, but need not, be formed of a single piece of material, such as sheet metal, includes a lip 12, or other suitable receiving feature, for catching a plate that attaches to the glass of a pane of a window (not shown) of a vehicle 20. In the figures described below, but without limitation, the portion of the vehicle that is shown is, without limitation, a portion of the vehicle body side, which may be referred to below as the vehicle. Other aspects of the vehicle in which a window, or other movable component the position of which is regularly selected by the user, could also be limited by assemblies and methods according to the present invention.

In the illustrated embodiment, the lip 12 defines a horizontal channel (not directly visible in this figure) that is generally perpendicular to an axis defining a primary direction of travel of the window pane when opening and closing. In the illustrated embodiment, that primary axis is generally vertical, though it need not be precisely so. Similarly, a slot 14 in the vehicle 20 accommodates and provides a guide for laterally confining movement of the up stop 10.

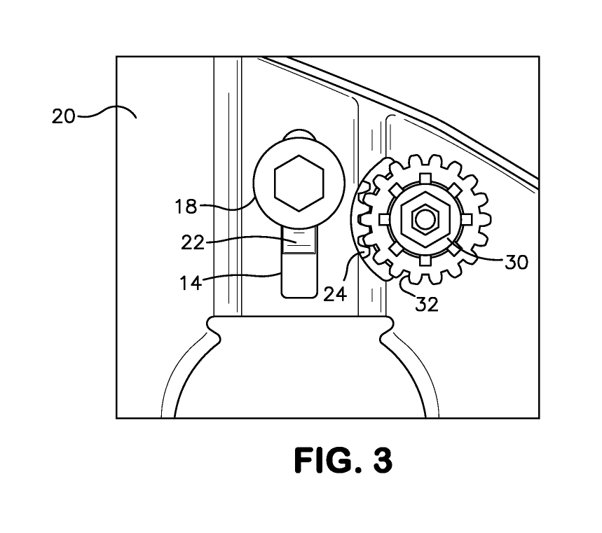

The up stop 10 is provided with a mechanism for its fixation and release, which in the illustrated embodiment involves an orifice 16 for receiving a screw 18 having a shaft diameter sized to fit moveably within slot 14, but without excess lateral play. The up stop 10 is further provided, in the illustrated embodiment, with an optional tab 22 shown in further detail in FIG. 3. As described in that Figure in further detail, tab 22 provides a mechanism for adjusting the up stop 10 in a direction perpendicular to the plane of the up stop 10. The screw 18 thus provides, and is an example of, a fixation device for the up stop 10. When sufficiently tight, the fixation device provided by screw 18 holds the up stop 10 firmly in place, so that the assembly can reliably fulfill its role of providing a stop at a preselected position along the axis of motion of the window and within the range of travel of the up stop 10. When loosened, the screw (or other fixation device) 16 allows translation of up stop 10 between positions along the primary axis. When re-tightened, fixation device (screw) 18 maintains up stop 10 in the adjusted position. Other non-screw embodiments of the fixation device 18 are possible and within the scope of the present invention.

The up stop 10 in FIG. 2 includes an engageable interface 24 arranged so that, when acted upon, actuates translation of the up stop 10 along the primary axis of motion, defined by slot 14. As also shown in FIG. 2, an adjustment component 30 is also provided, in an embodiment of another aspect of the present invention, with an engageable interface 32 configured to mate with the engageable interface 24 of up stop 10. In the illustrated embodiment, but without limitation, the engageable interfaces 24 and 32 comprise gear teeth; yet numerous other moving engagement mechanisms, used for the transfer of mechanical energy, could be used.

The adjustment component 30 may be a gear borne in the vehicle 20 and rotatable in a plane parallel to the vehicle 20 and collocated with the plane of the up stop 10. The adjustment component 30 is provided with engageable features 32 complementary to those of the up stop, and it is mounted and sized so that, when actuated, the engageable features 32 engage and act upon the complementary engageable features of the up stop 10. In the illustrated embodiment, the adjustment component 30 comprises a gear, is rotatable, has a preselected diameter, and is provided with radially extending and regularly-spaced teeth 32. Other embodiments of the adjustment component 30 are also possible in accordance with known methods of mounting linear, rotational and other components.

In the embodiment shown in FIG. 2, the surface of the vehicle 20, upon which adjustment component 30 is mounted, occupies a plane parallel to, but displaced from, the plane in which slot 14 is formed and in which up stop 10 is mounted. The surface of adjustment component 30 is provided with an accommodating curved slot through which the teeth 32 of adjustment component 30 pass in order to contact and act upon teeth 24 of up stop 10. In other words, in this embodiment (though not necessarily required for the invention), the adjustment component, including its engageable features, are on an interior side of the vehicle 20, while the up stop 10, including its respective engageable features 10, complementary to those of the adjustment component 30, are provided on an exterior side of the vehicle 20. In this way, but without limitation, actuation of the adjustment component 30 and, with it, the up stop 10 and the limit of the extent of travel of the window pane, are all adjustable from the interior of the vehicle in accordance with this aspect of the present invention.

As is also visible in FIG. 2, an embodiment of the adjustment component 30 may be provided with a mechanism retaining component providing resistance to movement. In accordance with an aspect of the present invention, this retention mechanism maintains the rotational position of the adjustment component 30 and, with it, the position along the primary axis of the up stop 10. In the illustrated embodiment of this aspect of the present invention, the retention function is provided by a rosebud, though alternative resistance or retention means may be used in accordance with the invention.

FIG. 3 shows the embodiment of the invention shown in FIG. 2, as viewed from the reverse position, i.e., from a position on the interior of the vehicle. Slot 14 in the vehicle 20 is visible, and at the top of slot 14 is the fixation device 18, here a screw, of up stop 10. The head of the screw 18 (the fixation device) is visible, and therefore accessible, from the interior of the vehicle 20. Just below screw 18, the tab 22 of up stop 10 is visible. The tab 22, which may be bent as shown in the illustrated embodiment, provides fore/aft guidance in the slot 14, that is in a direction perpendicular to the plane of the slot 14 and the panel in which it is formed. Also visible from the view shown in FIG. 3 are the adjustment component 30, which, in the illustrated embodiment, is in the form of a gear, as well as the engageable features, or gear teeth 32. The adjustment component 30 is provided with a tool-engageable feature, which may be contacted by a preselected tool (not shown), in order to be actuated during a maintenance procedure addressed to adjusting the up stop 10. The tool-engageable feature may comprise any feature accessible by a tool, included but not limited to mechanical tools, such as external and internal (Allen) hex arrangements, flat and Phillips head screw configurations, and others, without limitation.

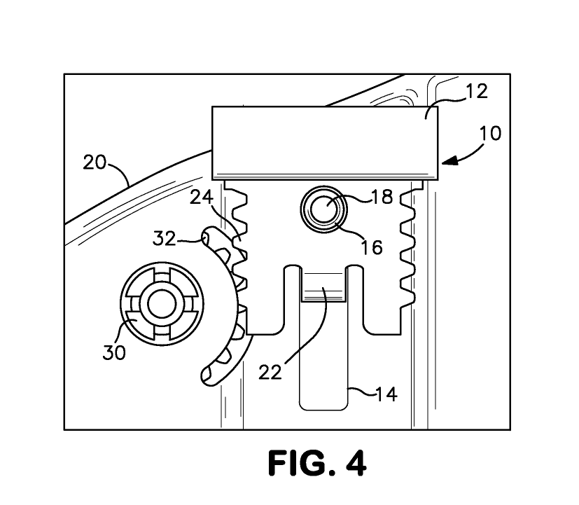

FIG. 4 shows the embodiment of FIGS. 2 and 3, from the exterior vantage point reflected in FIG. 2. In FIG. 4, the up stop 10 is in a position different from the one shown in FIG. 2. Namely, one can see from the length of the slot 14 in FIG. 4, that the up stop 10 is at or near the peak of its vertical limit. Up stop 10, in the illustrated embodiment, but without limitation, includes engageable interfaces, here gear-like features, on both of its edges, so that a single model of the part can be used on both right and left sides of the vehicle.

Specific arrangements and embodiments described above provide examples of the principles covered by the appended claims and their equivalents, but also include many other embodiments and variations, as well as objects and advantages, that may not be explicitly described in this document but that would nevertheless, be appreciated by those skilled in the field of this invention. For example, but without limitation, structural or functional elements might be rearranged, or method steps reordered, consistent with the present invention. Similarly, components described above as involved in carrying out the invention may comprise single or multiple parts, consistent with the function of the invention and without limitation to the particular illustrated embodiment. Similarly, principles according to the present invention, and systems and methods that embody them, could be applied to other examples, which, even if not specifically described here in detail, would nevertheless fall within the scope of the appended claims.

We claim:

1. An assembly for adjusting a position of a window of a vehicle, the window having a primary axis of motion when opening and closing, the assembly comprising:
a stop mechanism defining a limit on motion of the window along the primary axis, the stop mechanism being movably mounted with respect to the vehicle and having an engageable adjustment interface; and
an adjustment component mounted to the vehicle proximate the stop mechanism, the adjustment component having an interface for engaging the adjustment interface of the stop mechanism.

2. The assembly according to claim 1, wherein the adjustment component is mounted to permit it to be moved during an adjustment operation, such that the motion of the adjustment component causes an adjustment in the position of the stop mechanism, whereby the position of a limit of the window's position along the primary axis of motion is adjusted.

3. The assembly according to claim 2, wherein the engageable adjustment interface of the stop mechanism comprises a toothed configuration, and the engagement interface of the adjustment component comprises a toothed configuration complementary to the toothed configuration of the adjustment interface.

4. The assembly according to claim 3, wherein the adjustment component is substantially rounded and rotatable, and wherein rotation of the adjustment component causes, through moving engagement of the teeth of the adjustment component with those of the stop mechanism, movement of the stop mechanism from a first position to a second position.

5. The assembly according to claim 2, wherein the stop component is held in place by a releasable fixation device, and movement of the adjustment component, and with it the stop component, is possible when the releasable fixation device is released.

6. The assembly according to claim 1, wherein the vehicle has an interior and an exterior, and the adjustment component comprises a tool-receiving feature, the tool-receiving feature coupled to the engagement interface of the adjustment component, and wherein the tool-receiving feature is provided on a surface of the adjustment component accessible from a position in the interior of the vehicle.

7. The assembly according to claim 1, further comprising measurement indicia provided on a surface of the vehicle that is fixed relative to the stop mechanism, the measurement indicia providing a reference for fine adjustment of the position of the stop.

8. The assembly according to claim 6, wherein the fixation device for the stop mechanism comprises a screw, the screw having a tool-receiving feature, the tool-receiving feature of the screw accessible, like the tool-receiving feature of the adjustment component, from the interior of the vehicle, such that loosening and tightening of the fixation device and application of a tool to the tool-receiving feature of the adjustment component, can be coordinated to adjust the stop mechanism.

9. The assembly according to claim 6, wherein the tool comprises a wrench.

10. The assembly according to claim 6, wherein the tool comprises a screw driver.

11. An device for adjusting a position of a window of a vehicle, the window having a primary axis of motion when opening and closing, the device for use with an adjustment component mounted to the vehicle proximate the device, the adjustment component having an engagement interface for effecting an adjustment, the device comprising:
a stop for defining a limit on motion of the window along the primary axis, the stop mechanism being mounted to be movable, along the primary axis, with respect to the vehicle, and having an engageable adjustment interface, the engageable adjustment interface adapted to be engaged by the engagement interface of the adjustment component.

12. The device according to claim 11, wherein the adjustment component is mounted to permit it to be moved during an adjustment operation, such that the motion of the adjustment component causes an adjustment in the position of the stop, whereby the position of a limit of the window's position along the primary axis of motion is adjusted.

13. The device according to claim 12, wherein the engagement interface of the adjustment component comprises a toothed configuration, the stop further comprising an engageable adjustment interface comprising a toothed configuration complementary to the toothed configuration of the adjustment interface.

14. The assembly according to claim 13, wherein the adjustment component is substantially rounded and rotatable, and wherein rotation of the adjustment component causes, through moving engagement of the teeth of the adjustment component with those of the stop, movement of the stop from a first position to a second position.

15. The assembly according to claim 11, wherein the stop is held in place by a releasable fixation device, and movement of the adjustment component, and with it the stop, is possible when the releasable fixation device is released.

16. The assembly according to claim 11, wherein the vehicle has an interior and an exterior, and the adjustment component comprises a tool-receiving feature, the tool-receiving feature coupled to the engagement interface of the adjustment component, and wherein the tool-receiving feature is provided on a surface of the adjustment component accessible from a position in the interior of the vehicle.

17. The assembly according to claim 11, further comprising measurement indicia provided on a surface of the vehicle that is fixed relative to the stop, the measurement indicia providing a reference for fine adjustment of the position of the stop.

18. The assembly according to claim 15, wherein the fixation device for the stop comprises a screw, the screw having a tool-receiving feature, the tool-receiving feature of the screw being accessible, like the tool-receiving feature of the adjustment component, from the interior of the vehicle, such that loosening and tightening of the fixation device and application of a tool to the tool-receiving feature of the adjustment component, can be coordinated to adjust the stop.

19. The assembly according to claim 16, wherein the tool comprises a wrench.

20. The assembly according to claim 16, wherein the tool comprises a screw driver.

21. An assembly for adjusting the position of a stop mechanism for a window of a vehicle, the window having a primary axis of motion when opening and closing and the stop mechanism placing a limit on motion of the window along the primary axis, the stop mechanism also being movably mounted with respect to the vehicle and having an engageable adjustment interface, the assembly comprising:
an adjustment component mounted to the vehicle proximate the stop mechanism, the adjustment component having an interface for engaging the adjustment interface of the stop mechanism; the adjustment component mounted to permit it to be moved during an adjustment operation, such that the motion of the adjustment component causes an adjustment in the position of the stop mechanism, whereby the position of a limit of the window's position along the primary axis of motion is adjusted.

22. The assembly according to claim 21, wherein the engageable adjustment interface of the stop mechanism comprises a toothed configuration, and the engagement interface of the adjustment component comprises toothed configuration complementary to the toothed configuration of the adjustment interface.

23. The assembly according to claim 22, wherein the adjustment component is substantially rounded and rotatable, and wherein rotation of the adjustment component causes, through moving engagement of the teeth of the adjustment component with those of the stop mechanism, movement of the stop mechanism from a first position to a second position.

24. The assembly according to claim 22, wherein the stop mechanism is held in place by a releasable fixation device, and movement of the adjustment component, and with it the stop mechanism, is possible when the releasable fixation device is released.

25. The assembly according to claim 21, wherein the vehicle has an interior and an exterior, and the adjustment component comprises a tool-receiving feature, the tool-receiving feature coupled to the engagement interface of the adjustment component, and wherein the tool-receiving feature is provided on a surface of the adjustment component accessible from a position in the interior of the vehicle.

26. The assembly according to claim 21, further comprising measurement indicia provided on a surface of the vehicle that is fixed relative to the stop mechanism, the measurement indicia providing a reference for fine adjustment of the position of the stop.

27. The assembly according to claim 25, wherein the fixation device for the stop mechanism comprises a screw, the screw having a tool-receiving feature, the tool-receiving feature of the screw accessible, like the tool-receiving feature of the adjustment component, from the interior of the vehicle, such that loosening and tightening of the fixation device and application of a tool to the tool-receiving feature of the adjustment component, can be coordinated to adjust the up stop.

28. The assembly according to claim 25, wherein the tool comprises a wrench.

29. The assembly according to claim 25, wherein the tool comprises a screw driver.

30. A method for adjusting a limit on a position of a window of a vehicle, wherein the limit is defined by a stop movably mounted on the vehicle and the stop is acted upon by an adjustment component separately mounted on the vehicle, the method comprising the steps of:
engaging the adjustment component with a tool;
actuating the adjustment component with the engaged tool to cause a resultant movement of the stop; and
ceasing actuation of the adjustment component with the engaged tool when the stop has reached a desired position.

31. The method according to claim 30, wherein the stop is held in place by a fixation element capable of being loosened and tightened such that the stop is fixed when the fixation element is tightened, the method further comprising a step, prior to actuating the adjustment component, of loosening the fixation element, and another step, following ceasing actuation of the adjustment component, of tightening the fixation element.

32. The method according to claim 31, wherein reference indicia are provided in fixed manner relative to the stop, further comprising the step of actuating the adjustment component to achieve a fine adjustment by comparison of the stop to the reference indicia.

33. The method according to claim 30, wherein the vehicle comprises an exterior and an interior, and wherein the step of actuation of the adjustment component comprises actuation of the adjustment component from the interior of the vehicle.
